(19) United States
(12) Patent Application Publication
(10) Pub. No.: US 2024/0260534 A1
(43) Pub. Date: Aug. 8, 2024

(54) Pet Grass Potty Station

(71) Applicant: Richard A. Carmody, III, Ringgold, GA (US)

(72) Inventor: Richard A. Carmody, III, Ringgold, GA (US)

(21) Appl. No.: 18/430,772

(22) Filed: Feb. 2, 2024

Related U.S. Application Data
(60) Provisional application No. 63/442,782, filed on Feb. 2, 2023.

(51) Int. Cl. A01K 1/01

(52) U.S. Cl. CPC A01K 1/0107

(57) ABSTRACT

A potty station provides a top layer, such as artificial grass having perforations therethrough directing fluid to a tray therebelow. The tray directs pee through a drain hole to a tank through hole in the tank. The hole in the tank has a check valve configured to permit the flow of fluid, while preferably retaining odor in the tank.

### CLAIM OF PRIORITY

The present invention claims the benefit of U.S. Provisional Patent Application No. 63/442,782 filed Feb. 2, 2023, which is incorporated herein by reference in its entirety.

### FIELD OF THE INVENTION

The present invention relates to an artificial grass pet potty training turf patch for indoor/outdoor use.

### BACKGROUND OF THE INVENTION

At least one company, Jaxpety, makes an artificial grass potty trainer pee turf patch with washable tray under the brand of Coziwow™. This is believed to be an improvement over potty pads. This design has a tufted artificial grass product above a drain tray which has a drain hole into a removable tray which collects the animal pee and allows a user to then discard the pee. While this is certainly an advantageous product, there are believed to be a number of shortcomings which can be overcome with improvements.

First of all, the removable tray is an open tray which could potentially allow for the pee to slosh around when dumping it. Additionally, the open tray allows the odor of the pee to permeate through an indoor environment. Furthermore, the tufted mat utilized in this design may be somewhat difficult to clean as it relates to ensuring that all the potential parts that come in contact with the pee of the pet could be adequately rinsed and cleaned so as not to smell, particularly when indoors.

Improvements over this design are believed to be advantageous in the marketplace.

### SUMMARY OF THE INVENTION

Accordingly, it is an object of many embodiments of the present invention to provide an improved artificial grass bathroom location for pets whether indoors or outdoors.

Accordingly, in accordance with the presently preferred embodiment of the present invention, an artificial grass top surface is provided which may either be a traditional tufted material as is used in the prior art or could be a non-tufted material such as that produced at Shein.com as an artificial plant product which has a plurality of artificial leaves extending above a plastic molded grid. This design is believed to easily allow liquid to penetrate therethrough while also supporting the paws of a pet during the potty process. Below this structure is located a tray which preferably does not direct to a centrally located hole (relative to front and back as well as side to side) as does the prior art product, but instead has an offset hole directed towards a side which can have a removable tank as opposed to a tray there below. Other embodiments may have a center drain. The removable tank preferably receives fluid from the drain tray through a check valve which preferably prevents odor from liquid in the tank from escaping from the tank if not at least significantly reducing that effect. By restraining the liquid in the tank in such a manner, odor is believed to be drastically reduced. Since the volume of pee is contained without an opening (other than a closed drain and the one-way check valve) splashing pee when removing and disposing is less likely than prior art designs.

The drain tray is preferably located atop a base and may be made as a separate component connect thereto. The tank preferably has a handle for sliding out at a front which can permit the ability to insert and pull out the tank relative to the base. A check valve is preferably located below the drain hole of the drain tray. First and second carry handles are useful to carry an at least partially full if not full tank. Two handles are believed to assist in providing stability for many embodiments. A spout location may be located in dotted lines on the figures and can receive a spout as is shown in other figures or a drain hole and cap may be provided for still other embodiments as sown in some of the figures. Multiple bases may be connected together with a curved seamed shroud so as there is no spillage between two adjacent units particularly when connected together. These and/or other connections may assist in preventing spillage between adjacent units. A set of dovetail connections on one side may be received in opposing slots of an adjacent base. A check valve such as the green drain gd3 waterless trap seal may be utilized to receive fluid from the drain tray into the tank while preventing odors from emanating from the tank.

Such a constructions can eliminate unfriendly potty pads which typically smell and are often unsightly. Many embodiments provide an easy to clean and easy to use potty station for one's pets. With the present construction, multiple bases can be connected together to provide a larger footprint such as for larger animals. Targets such as fire hydrants or other targets could be placed on top of the artificial grass if the various pets desire such use.

Many embodiments could be two feet long and one foot wide for the base and approximately ten inches by twelve inches long for the tank. The base height may be about three inches. The tank may have the capacity of about a gallon for many embodiments if not 0.92 gallons when at a full condition. Many embodiments could be made of 100% recycled plastic preferably in the United States and may be molded in various ways. For smaller pets, it may be that the tank can hold a sufficient volume for many days without needing to be emptied. For larger pets it is anticipated that the rate of emptying could be higher. Pour spouts such as those having a ball valve as illustrated, can be utilized such as where indicated in the drawings to provide a convenient way to empty the tank if the drain cap and drain port are not utilized. By utilizing the pour spout the spout can be extended and then dumped into a toilet or other appropriate location and then shut when the tank is reinserted in the base for continued use.

A non-stick coating may be applied to the grass/drain tray to be more hydrophobic such as beeswax or other appropriate material so as to maximize the flow of the pee to the tank to prevent as much as possible from drying and potentially smelling on the grass or drain tray.

### BRIEF DESCRIPTION OF THE DRAWINGS

The particular features and advantages of the inventions as well as other objects will be come from the following description taken in connection with the accompanying drawings to which:

FIG. 1 is a top plan view of an array of potty stations of a presently preferred embodiment of the present invention;

FIG. 2 is a detail cutaway view of the line A-A in FIG. 1;

FIG. 3 is an exploded front view of one of the potty stations shown in FIG. 1; and

FIG. 4 is a rear perspective view of a removable tank removed from the potty station.

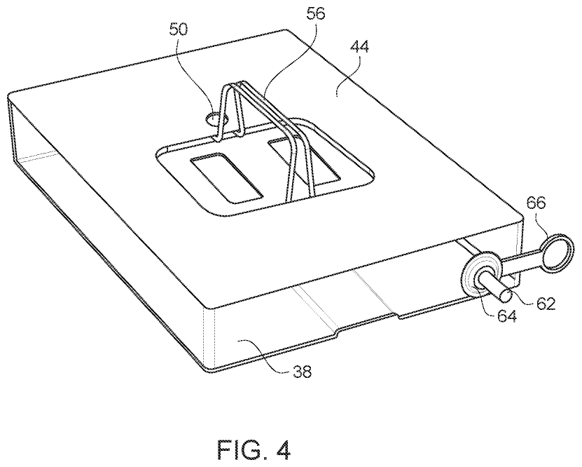

### DETAILED DESCRIPTION OF THE PREFERRED EMBODIMENTS

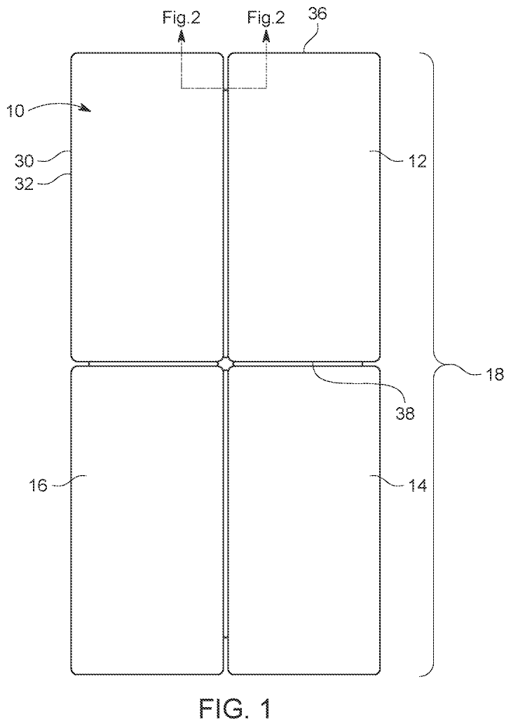

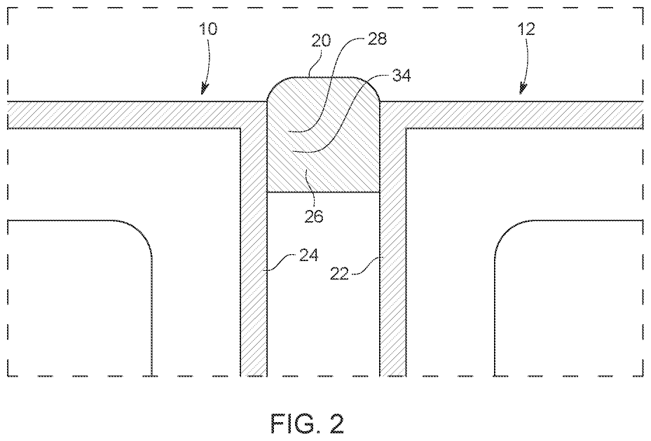

A presently preferred embodiment of the present invention provides a pet potty station 10. For some applications, multiple pet potty stations 10,12,14,16 may be utilized together to form an array 18, of stations 10,12,14,16, or other array 18 (See FIG. 1). When utilized as an array 18, each station 10-16, or at least some of stations 10-16 have overhangs 20, or curved shrouds, which may extend over an adjacent side 22 (See FIG. 2). While overhangs 20 may be separate components, it is anticipated that overhangs 20 extend from a first station 10 and past a side 24 of the first station 10 to extend over the side 22 of a second station 12 as shown in FIG. 2 or otherwise. Second station 12 may provide a ledge 26 extending past side 22 onto which foot 28 extending below overhang 20 rests so as to provide vertical support from below to the overhang 20. Front 36 and back 38 of stations 10-16 may have similar or dissimilar constructions as either or both of sides 22,24,30, etc. or not.

Side 30 may have connecting portions 32, such as dovetail extensions which can be received in slots 34 of side 24 of a corresponding station 12,14,16,18 so the stations are secured together.

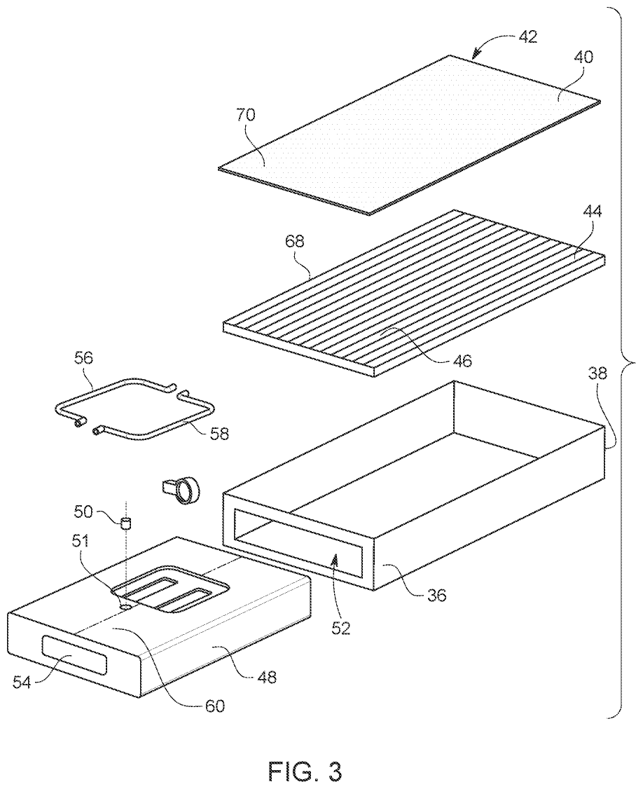

FIG. 3 shows an exploded view of a station 10. An artificial grass top surface or other top surface 40 may be provided which may either be a traditional tufted material as is used in the prior art or could be a non-tufted material such as that produced at Shein.com as an artificial plant product which has a plurality of artificial leaves extending above a plastic molded grid. A tufted top surface 40 could have holes 42 or other perforations therethrough, which could be punched or otherwise provided similar to a grid, or not. Such designs could allow liquid to penetrate therethrough while also supporting the paws of a pet during the potty process.

Below the top surface 40 is located a tray 44 which, for many embodiments, preferably does not direct to a central located hole relative to a perimeter of the tray 44 as does the prior art product, but instead has an offset hole 46 directed towards, or closer to one side 36 than an opposing side 38. A removable tank 48 may be located below the tray 44, and since, for at least some embodiments, the hole 46 is closer to side 36 than 38, it can facilitate the tank being easily accessible from side 36, although other embodiments may be constructed differently and/or. Other embodiments may have a center drain 46.

The removable tank 48 preferably receives fluid from the drain tray 44 through a check valve 50 which preferably prevents odor from liquid in the tank 48 from escaping from the tank 48 if not at least significantly reducing that effect. By restraining liquid in the tank 48 in such a manner, odor is believed to be drastically reduced. Green Drain, Inc. makes a waterless trap seal that works particularly well for this application.

The drain tray 44 is preferably located atop a portion of a base 52 and may be made as a separate component and/or connect thereto. The tank 44 preferably has a handle 54 which may be molded into the drain tray 44 or otherwise provided for sliding out at a front 36 which can permit the ability to insert and pull out the tank 44 relative to the base 36. The check valve 50 is preferably located below the drain hole 46 of the drain tray 44, and preferably collinearly aligned therewith at hole 51. First and second carry handles 56,58 are useful to carry an at least partially full if not full tank 44. Two handles 56,58 are believed to assist in providing stability for many embodiments, such as by being symmetrical about center line 60. A spout 62 may be and/or a drain hole 64 and cap 66 may be provided for preferred or other embodiments as shown in some of the figures.

Such constructions may eliminate, or at least greatly reduce, unfriendly potty pads which typically smell and are often unsightly. Many embodiments provide an easy to clean and easy to use potty station 10 for one's pets. With the present construction, multiple bases can be connected together to provide a larger footprint such as for larger animals. Targets such as fire hydrants or other targets could be placed on top of the artificial grass or top layer 40 if the various pets desire such use.

Many embodiments could provide stations 10-16 about two feet long and one foot wide for the base and approximately ten inches by twelve inches long for the tank 48. The base 52 height may be about three inches. The tank 48 may have the capacity of about a gallon for many embodiments if not 0.92 gallons when at a full condition. Many embodiments could be made of 100% recycled plastic preferably in the United States and may be molded in various ways. For smaller pets, it may be that the tank 48 can hold a sufficient volume for many days without needing to be emptied. For larger pets it is anticipated that the rate of emptying could be higher. Pour spouts 62 such as those having a ball valve as illustrated, can be utilized such as where indicated in the drawings to provide a convenient way to empty the valve tank if the drain cap 66 and drain spout 62 are not utilized. By utilizing a pour spout 62 the spout 62 can be extended and then dumped into a toilet or other appropriate location and then shut when the tank 48 is reinserted in the base for continued use. The tank 48 preferably has a contained valve therein (holding pee) with the drain hole 64 and check valve 50 permitting access so that, when carried, the tank 44 preferably does not spill.

A non-stick coating 68,70 may be applied to the grass or top layer 40/drain tray 44 to be more hydrophobic such as beeswax or other appropriate material so as to maximize the flow of the pee to the tank to prevent as much as possible from drying and potentially smelling on the grass or drain tray.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

Having thus set forth the nature of the invention, what is claimed herein is:

1. A potty station comprising:
an upper artificial grass layer having a porosity permitting fluid to flow therethrough;
a base having a tray thereon, said tray directing fluid to a drain hole;
a drain tank located below the drain hole, said drain tank having a hole receiving fluid from the drain hole in the tray, said drain tank having a check valve at the hole of the drain tank permitting the flow of fluid into the tank while restricting the flow of odors from the tank out of the hole.

2. The potty station of claim 1 wherein the drain tank is received in a first side of the base.

3. The potty station of claim 2 wherein the drain tank has a handle directed towards the first side of the base.

4. The potty station of claim 1 further comprising at least one carry handle upwardly directly relative to an upper surface of the drain tank.

5. The potty station of claim 4 wherein the at least one carry handle further comprises a pair of symmetrically disposed handles.

6. The potty station of claim 3 further comprising a drain along a second side of the drain tank.

7. The potty station of claim 6 wherein the second side of the drain tank is opposite the first side.

8. The potty station of claim 6 further comprising a spout at the drain.

9. The potty station of claim 1 wherein the base further comprises a first side having an overhang extending over the overhang.

10. The potty station of claim 9 having a slot in the first side for receiving a connector portion of an adjacent potty station.

11. The potty station of claim 10 wherein the connector portion is a dovetail extension and when the adjacent potty station has the dovetail portion in the slot of the potty station, the potty station and adjacent potty station are secured together.

12. The potty station of claim 11 wherein the potty station and adjacent potty station are a portion of an array of potty stations adjacently disposed together.

13. The potty station of claim 9 further comprising an adjacent potty station having a side disposed below the overhang and facing the potty station.

14. The potty station of claim 13 wherein the adjacent potty station has a ledge extending from the side facing the potty station, and the overhang has a downwardly extending leg contacting the ledge.
